(19) United States
(12) Patent Application Publication
(10) Pub. No.: US 2018/0244546 A1
(43) Pub. Date: Aug. 30, 2018

(54) ZINC ION WATER TREATMENT DEVICE AND MANUFACTURING METHOD THEREFOR

(71) Applicant: JH WATERWAY CO., LTD., Gyeonggi-do (KR)

(72) Inventor: Hak-Sub SHIM, Seoul (KR)

(21) Appl. No.: 15/756,087

(22) PCT Filed: Dec. 2, 2015
(86) PCT No.: PCT/KR2015/013089

§ 371 Date: Feb. 28, 2018

(30) Foreign Application Priority Data
Sep. 4, 2015 (KR) 10-2015-0125770

(51) Int. Cl. C02F 1/46; C02F 1/461; C02F 5/02; C23F 13/16; B22F 5/10; B22F 3/10

(52) U.S. Cl. CPC C02F 1/4602; C02F 1/46176; C02F 1/46109; C02F 5/02; C23F 13/16; B22F 5/10; B22F 2301/30; C02F 2001/46157; C02F 2001/46133; C02F 2303/08; C02F 2201/004; B22F 2201/20; B22F 3/10

(57) ABSTRACT

The present invention relates to a zinc ion water treatment device comprising: a zinc block having a plurality of through holes in the body thereof; and a fluororesin block having another plurality of through holes, wherein the side surface of the fluororesin block is provided in concave and convex forms.

### TECHNICAL FIELD

The present disclosure relates to a zinc ion water treatment device including a zinc block and a fluororesin block and a method for manufacturing the same.

### BACKGROUND ART

In general, chemicals have mainly been used for the purpose of removing or preventing scale or rust in a pipe in which a fluid flows. Recently, however, an ion water treatment device known as a scale-buster has been used.

FIG. 1 is a cross-sectional view of an ion water treatment device according to the related art. In the ion water treatment device, a zinc block 20, allowing a sacrificial anode to be formed in a body 10 formed of a brass material, and a fluororesin block 30, generating a potential electrostatic charge using flow of a fluid to induce precipitation of harmful substances included in the fluid, are included therein. Here, in the zinc block 20 and the fluororesin block 30, a plurality of through holes 21 and 31, for fluid flow, are formed.

The ion water treatment device described above has excellent effects in extending the lifespans of old pipes and improving water quality by using a sacrificial anode method of the zinc block 20, and has the advantage of more easily filtering a foreign substance using a filter by neutralizing charged colloids in water by the fluororesin block 30 to aggregate and precipitate the colloids.

The ion water treatment device described above is a single independent configuration, and is installed between two neighboring pipes. Moreover, to be coupled to a pipe, a flange 41 is formed in each of both ends of an ion water treatment device.

However, the flange 41 has a structure, fixed to the body 10 of the ion water treatment device. When an ion water treatment device is additionally mounted on an existing pipe, if a hole of a flange 41, provided in a pipe, and a hole of a flange 41, provided in an ion water treatment device, are not aligned, it may be difficult to install an ion water treatment device.

Meanwhile, in general, a zinc plate for a scale-buster is manufactured by naturally cooling liquid zinc in air. However, as oxygen is easily dissolved in liquid zinc and is then bound to zinc, zinc oxide (ZnO) may be easily generated. Such zinc oxide has properties of not easily being dissolved in water, even in a liquid, so a generated amount of zinc ions and electrons, generated in zinc metal having the same volume, may be reduced.

Moreover, in general, a body of an ion water treatment device is formed of a brass material, but a pipe connected thereto is formed of a different material. Thus, potential corrosion may occur in a connection portion. In addition, insulation at the connection portion may not be sufficiently performed, so loss of a potential electrostatic charge, generated from a fluororesin block, may be generated. Thus, performance of an ion water treatment device may be deteriorated.

### DISCLOSURE

### Technical Problem

An aspect of the present disclosure may provide a zinc ion water treatment device capable of increasing a contact area between a body of a zinc ion water treatment device and a fluid, increasing an area of a zinc block adjacent to a body, and further increasing a concentration of zinc ions released from a zinc block.

Another aspect of the present disclosure may provide a zinc ion water treatment device capable of preventing zinc oxide (ZnO) from being generated in a zinc block by forming the zinc block by sintering solid zinc in a vacuum chamber to produce liquid zinc and performing cooling at room temperature in the vacuum chamber, and increasing a generation amount of zinc ions and electrons generated in a zinc block having the same volume, and a method for manufacturing the same.

Another aspect of the present disclosure may provide a zinc ion water treatment device having a rotary flange on which a zinc ion water treatment device is more easily mounted, by easily aligning fastening holes between flanges, by configuring the flanges provided in both ends of a zinc ion water treatment device to be rotated.

Another aspect of the present disclosure may provide a zinc ion water treatment device having a rotary flange preventing potential corrosion caused by a difference in material between a zinc ion water treatment device and a pipe, by forming an insulating layer between a body of the zinc ion water treatment device and a flange.

### Technical Solution

According to an aspect of the present inventive concept, a zinc ion water treatment device includes a zinc block having a plurality of through holes in a body, and a fluororesin block having another plurality of through holes, wherein a side surface of the fluororesin block is formed to have concave and convex forms to allow a fluid to flow while the fluid is in contact with the body and the fluororesin block.

The zinc ion water treatment device may preferably include: a rotary flange coupled to each of both ends of the body of the zinc ion water treatment device to be rotated, and having a plurality of fastening holes to be coupled to a flange of a neighboring pipe; a fixing member installed in each of both ends of the body of the zinc ion water treatment device and fixing the rotary flange to the body; an insulating layer formed on an inner surface of the rotary flange, and preventing the rotary flange from being directly in contact with the body and the fixing member to prevent potential corrosion by contact between metals different from each other, wherein a protrusion for fixing a position of the rotary flange may be formed on an external surface of both ends of the body to allow the rotary flange to be rotated while being located between the protrusion and the fixing member.

An area of a side surface of a fluororesin block adjacent to the body may be 30% to 90% of a total area of a side surface of the body.

In a longitudinal direction in which a fluid flows, a ratio of a length of the fluororesin block and a length of the zinc block may be 1:2 to 1:5.

The insulating layer may be formed to be extended from one side surface of a rotary flange corresponding to the protrusion to the other side surface corresponding to a fixing member through an inner surface of the rotary flange.

The fixing member may be preferably screw coupled to the body.

An O-ring for ensuring air tightness may be preferably further installed between the body and the fixing member.

The zinc block may be preferably manufactured by sintering solid zinc at 400° C. to 800° C. in a vacuum chamber, and performing cooling at room temperature in the vacuum chamber.

According to an aspect of the present inventive concept, a method for manufacturing a zinc ion water treatment device including a zinc block having a plurality of through holes in a body and a fluororesin block having another plurality of through holes, includes: sequentially providing a zinc block and a fluororesin block in a body, wherein a side surface of the fluororesin block is formed to have concave and convex forms to allow a fluid to flow while being in contact with the body and the fluororesin block, and the zinc block is manufactured by sintering solid zinc in a vacuum chamber, and performing cooling at room temperature in the vacuum chamber.

The solid zinc may preferably be produced to be liquid zinc by performing sintering at a temperature of 400° C. to 800° C. in the vacuum chamber.

### Advantageous Effects

According to an exemplary embodiment in the present disclosure, a zinc ion water treatment device may reduce an area of a portion of a fluororesin block adjacent to a body, may increase an area of a portion of a body adjacent to a fluid, may increase an area of a zinc block adjacent to a body, and thus significantly increasing the content of zinc ions released from a zinc block, thereby improving effects of extending a lifespan of an old pipe and improving a water quality.

In addition, a flange for coupling a zinc ion water treatment device to an existing pipe may have a rotatable structure. Even in the case that fastening holes formed in a flange of a pipe and formed in a flange of a zinc ion water treatment device are not aligned, a rotary flange may rotate, so the fastening holes may be easily aligned, thereby improving productivity.

Moreover, an insulating layer is formed between a body of a zinc ion water treatment device formed of brass and a rotary flange, so potential corrosion caused by contact of different metals may be prevented, and flow of electricity between a zinc ion water treatment device and a pipe is entirely blocked. Thus, loss of static electricity generated between a fluororesin block and a fluid may be prevented.

In addition, a zinc ion water treatment device capable of forming liquid zinc by sintering solid zinc in a vacuum chamber, and forming a zinc block by performing cooling at room temperature in the vacuum chamber, suppressing generation of zinc oxide (ZnO) in a zinc block, and increasing a generation amount of zinc ions and electrons, generated in a zinc block having the same volume, and a method for manufacturing the same, may be provided.

### DESCRIPTION OF DRAWINGS

FIG. 1 is a cross-sectional view of an ion water treatment device according to the related art.

FIG. 2 is a cross-sectional view of an ion water treatment device according to the related art.

FIG. 3 is a cross-sectional view of a zinc ion water treatment device according to an exemplary embodiment.

FIG. 4 is a cross-sectional view of a zinc ion water treatment device according to an exemplary embodiment.

FIG. 5 is a graph in which a concentration of zinc ions released from a zinc ion water treatment device of an Example and a Comparative Example.

### BEST MODE FOR INVENTION

Hereinafter, preferred embodiments of the present disclosure will be described. However, the embodiments of the present disclosure may be modified into various other forms, and the scope of the present disclosure is not limited to the embodiments described below. Further, the embodiments of the present disclosure are provided to more fully explain the present disclosure to those skilled in the art.

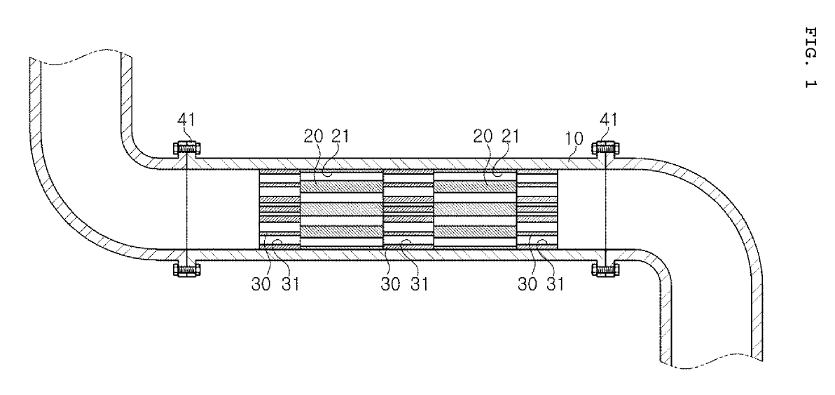

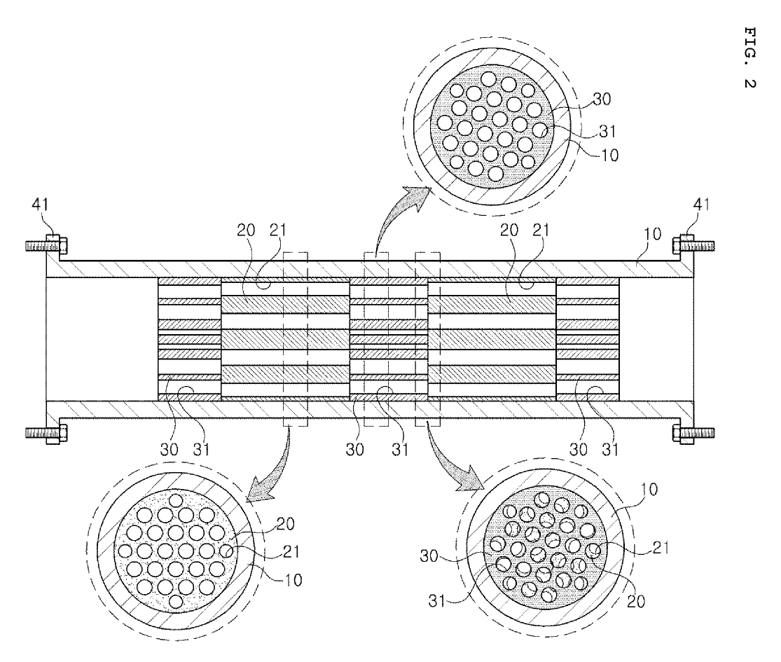

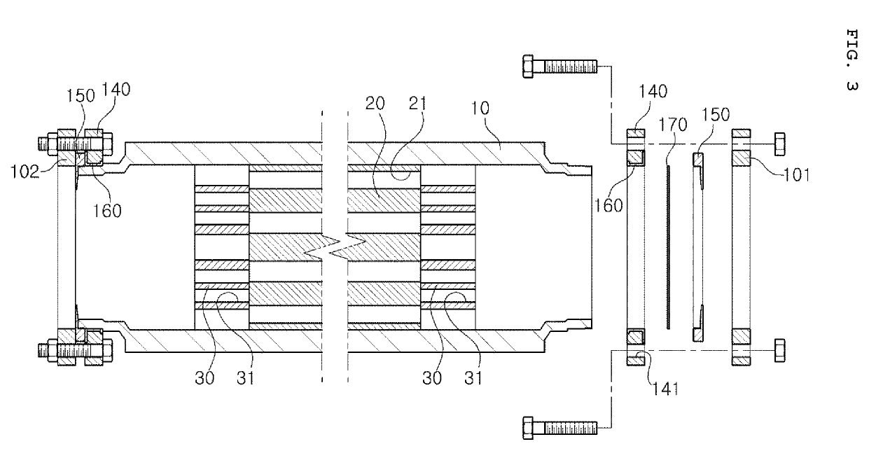

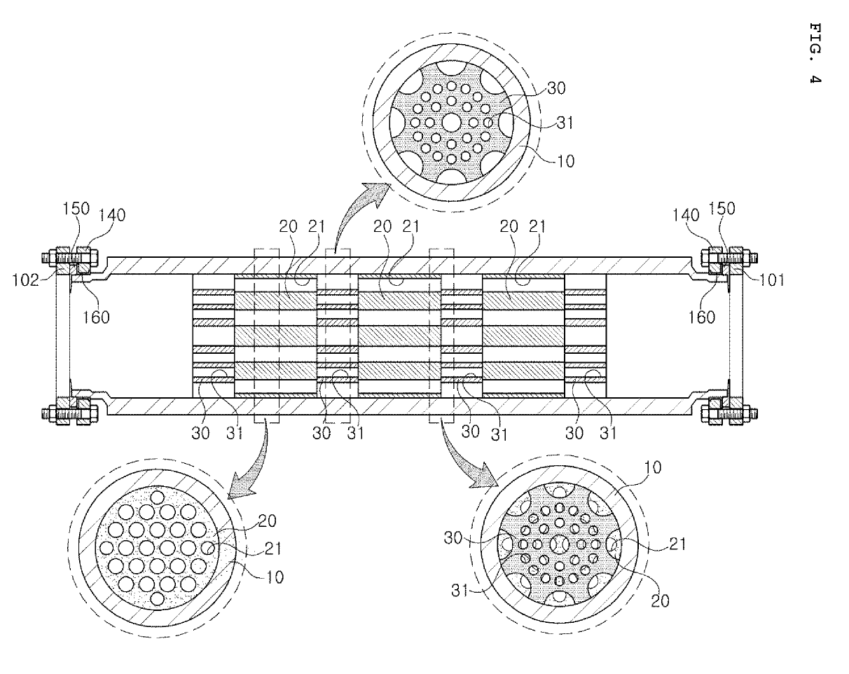

FIGS. 1 and 2 are cross-sectional views of an ion water treatment device according to the related art, and FIGS. 3 and 4 are cross-sectional views of a zinc ion water treatment device according to an exemplary embodiment.

An aspect of the present disclosure may provide a zinc ion water treatment device including a zinc block 20 having a plurality of through holes 21 in a body 10, and a fluororesin block 30 having another plurality of through holes. In the zinc ion water treatment device, a side surface of the fluororesin block 30 is formed to have concave and convex forms to allow a fluid to flow while being in contact with the body 10 and the fluororesin block 30.

The zinc ion water treatment device according to the present disclosure, installed in a pipe in which a fluid flows to remove scale and rust in a pipe and to prevent scale and rust from being occurring, preferably includes a cylindrical body 10, a zinc block 20 disposed in the body 10, and a fluororesin block 30 disposed in the body 10.

The body 10 is a cylindrical pipe formed of a brass material. To allow a rotary flange 140 to be coupled to both ends of the body, both ends of the body 10 may be configured to have an outer diameter corresponding to an inner diameter of the flange. To prevent the rotary flange 140 from flowing in a longitudinal direction of the body 10, a protrusion, restraining one side surface of the rotary flange 140, is preferably formed in each of both ends of the body.

The zinc block 20 is installed in the body 10, and a plurality of through holes for fluid flow are preferably formed therein. The zinc block 20 may allow a sacrificial anode to be formed in the body 10 formed of a brass material to prevent a pipe from being corroded, and may be dissolved in a fluid flowing through a zinc ion water treatment device to suppress the generation of rust and various types of bacteria in a pipe.

The fluororesin block 30 is installed in a position in the body 10, different from that of the zinc block 20, and a plurality of through holes for fluid flow are preferably formed therein. The fluororesin block 30 allows a potential electrostatic charge to be generated, as a fluid flows in a surface. The potential electrostatic charge neutralizes a charged colloid in the fluid, and allows the charged colloid to agglomerate. Thus, filtration efficiency of a foreign substance contained in a fluid is increased.

In this case, regarding a form of the fluororesin block 30, a side surface of the fluororesin block 30 preferably has concave and convex forms, as illustrated in FIG. 3 and FIG. 4, to allow a fluid to flow while being in contact with the body 10 and the fluororesin block 30.

A portion of a side surface of the fluororesin block 30 is only adjacent to the body 10, so an area in which a flowing fluid is in contact with the body 10, that is, brass, may be increased, while an area of the zinc block 20, which can be adjacent to brass, may be increased. Thus, an amount of zinc ions released from the zinc block 20 may be significantly increased.

In detail, an area of a side surface of the fluororesin block 30, adjacent to the body 10, is preferably 30% to 90% of a total area of a side surface of the body 10. In this case, if an area of a side surface of the fluororesin block 30 adjacent to the body 10, to a total area of the body 10, is less than 30%, problems in which it is difficult to manufacture the fluororesin block 30 and manufacturing costs are increased may occur. If the area thereof exceeds 90%, problems in which an area of processing a fluororesin material is increased, so cracking easily occurs, and manufacturing costs are increased may occur.

Furthermore, in a longitudinal direction in which a fluid flows, a ratio of a length of the fluororesin block 30 and a length of the zinc block 20 is preferably 1:2 to 1:5. In this case, if a length of the zinc block 20 is a length at a ratio of 1:2 or more, a sufficient amount of zinc may be eluted from a zinc ion water treatment device. If a length of the zinc block 20 exceeds a length at a ratio of 1:5, a contact area of fluororesin and brass is reduced, so a zinc elution volume may be reduced.

On the other hand, the zinc ion water treatment device according to the present disclosure is preferably a zinc ion water treatment device having the rotary flange 140, and particularly, a zinc ion water treatment device including: a rotary flange 140 coupled to each of both ends of the body 10 of the zinc ion water treatment device to be rotated, and having a plurality of fastening holes 141 to be coupled to flanges 101 and 102 of neighboring pipes; a fixing member 150 installed in both ends of the body 10 of the zinc ion water treatment device and fixing the rotary flange 140 to the body 10; and an insulating layer 160 formed on an inner surface of the rotary flange 140 and preventing the rotary flange 140 from being directly in contact with the body 10 and the fixing member 150 to prevent potential corrosion by contact between metals different from each other. Moreover, a protrusion for fixing a position of the rotary flange 140 is formed on an external surface of both ends of the body 10 to allow the rotary flange 140 to be rotated while being located between the protrusion and the fixing member 150.

The rotary flange 140 is a circular plate having a ring shape, and is configured by forming a plurality of fastening holes 141 into which a bolt to be coupled to the flanges 101 and 102 of a pipe is inserted. Moreover, the rotary flange is preferably coupled to the body 10 and rotated around the body 10 as an axis. The rotary flange 140 is preferably provided as two rotary flanges to be coupled to both ends of the body 10, respectively.

The fixing member 150 restrains the rotary flange 140 to prevent the rotary flange 140, screw coupled to an end of the body 10 and coupled to the body 10, from being separated from the body. On the other hand, for coupling the fixing member 150 to the body 10, an interlocked screw is preferably provided in an external surface of an end of the body 10 and an inner surface of the fixing member 150.

Moreover, to improve air tightness between the fixing member 150 and the body 10, an O-ring 170 is preferably installed between the fixing member 150 and the body 10.

The insulating layer 160 is preferably formed in an inner surface of the rotary flange 140 to prevent potential corrosion from occurring in a portion of the insulating layer to which the rotary flange 140 is coupled. In further detail, the insulating layer 160 is formed to have a structure extended from one side surface of the rotary flange 140 corresponding to a protrusion of the body 10 through an inner surface of the rotary flange 140 to the other side surface of the rotary flange corresponding to the fixing member 150, so as to allow the rotary flange 140 to have a completely non-contact state to the body 10 and the fixing member 150. The insulating layer 160 may be formed of urethane resin.

The insulating layer 160 described above is further formed in the rotary flange 140. Thus, even in the case that the rotary flange 140 is formed of the same material as that of a pipe to be connected thereto, potential corrosion may be prevented from occurring in a coupling portion of the body 10 and the rotary flange 140. Therefore, a range of choices for material of the rotary flange 140 is widened, thereby providing the advantage of increasing the freedom of design.

In the zinc ion water treatment device of the present disclosure configured as described above, for installation, when the flanges 101 and 102 of a pipe face the rotary flange 140 mounted on the zinc ion water treatment device, in the case in which fastening holes of two flange are not aligned, the rotary flange 140 is allowed to be rotated around the body 10, as an axis. Thus, the two fastening holes of the two flanges are allowed to be easily aligned, so the zinc ion water treatment device may be easily installed.

Moreover, the insulating layer 160, formed between the rotary flange 140 and the body 10, may serve to prevent potential corrosion from occurring between the rotary flange 140 and the body 10, and may serve to protect two components from friction generated between the rotary flange 140 and the body 10. In detail, the insulating layer prevents a potential electrostatic charge, generated between the fluororesin block 30 and water, from being lost, thereby preventing a reduction in a performance of the zinc ion water treatment device.

Meanwhile, the zinc block 20 of the present disclosure is preferably manufactured by sintering solid zinc in a vacuum chamber and performing cooling at room temperature in the vacuum chamber. In detail, the solid zinc is sintered under temperature conditions of 400° C. to 800° C. to be liquid zinc. Then, the liquid zinc is cooled at room temperature in the same vacuum chamber, and a zinc block is manufactured thereby. Thus, oxygen present in air being bound and zinc oxide being generated may be suppressed, and a generation amount of zinc ions and electrons, generated in a zinc block having the same volume, may be increased.

Another aspect of the present disclosure may provide a method for manufacturing a zinc ion water treatment device. In the method for manufacturing a zinc ion water treatment device, including a zinc block 20 having a plurality of through holes 21 in a body and a fluororesin block 30 having another plurality of through holes 31, sequentially providing the zinc block 20 and the fluororesin block 30 in a body is included therein. A side surface of the fluororesin block 30 is formed to have concave and convex forms to allow a fluid to flow while being in contact with the body and the fluororesin block 30, and the zinc block 20 is manufactured by sintering solid zinc in a vacuum chamber and performing cooling at room temperature in the vacuum chamber.

In this case, the sintering is preferably performed at a temperature of 400° C. to 800° C. In this case, if a sintering temperature is less than 400° C., a melting point of zinc is about 420° C., so sufficient sintering may not occur. Thus, it may be difficult to form sufficient liquid zinc. If the sintering temperature exceeds 800° C., when zinc, having been sintered, is placed in a mold and is then cooled, a large amount of bubbles occur. Thus, a quality of a product may be deteriorated.

### MODE FOR INVENTION

### Example

Hereinafter, the present disclosure will be described in detail with reference to Example, but is not limited by the following Examples.

### Experimental Example 1

As illustrated in FIG. 2, a zinc ion water treatment device, which includes a fixed flange 41, and in which the fluororesin block 30 and the zinc block 20 are sequentially disposed in the body 10, was prepared. In this case, the fluororesin block 30 was provided as three fluororesin blocks, while the zinc block 20 was provided as two zinc blocks (Comparative Example 1). In this case, the numbers of through holes 21 and 31, included in the fluororesin block 30 and the zinc block 20, were the same as each other.

Meanwhile, as illustrated in FIG. 4, a zinc ion water treatment device of Example 1, which includes the rotary flange 140, and in which the fluororesin block 30 and the zinc block 20 are sequentially disposed in the body 10, was prepared. In this case, the fluororesin block 30 was provided as four fluororesin blocks, while the zinc block 20 was provided as three zinc blocks (Example 1). In this case, in a direction in which a fluid flows, a length of the zinc block 20 is twice a length of the fluororesin block 30.

Moreover, a side surface of the fluororesin block 30 is formed to have concave and convex forms to allow a fluid to flow while being in contact with the body 10 and the fluororesin block 30. In this case, the concave and convex forms are formed to allow an area of a portion of the fluororesin block 30, adjacent to the body 10, to be 30% to an area of the body 10, in which the fluororesin block 30 is provided.

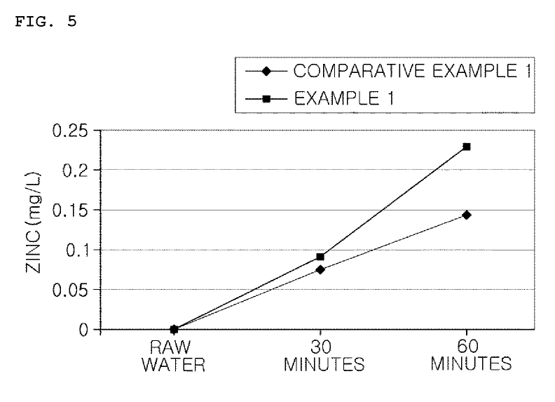

Raw water was provided to the zinc ion water treatment device of each of Example 1 and Comparative Example 1. In this case, the content of zinc ions was measured according to the treatment time, and a result thereof is illustrated in FIG. 5.

As illustrated in FIG. 5, in Comparative Example 1, a concentration of zinc ions is increased from 0.002 mg/L to 0.144 mg/L during the reaction for 60 minutes, while, in Example 1, a concentration of zinc ions is significantly increased from 0.002 mg/L to 0.23 mg/L during the reaction for 60 minutes. In this regard, Example 1 is confirmed that a rate of increase of zinc ions is 40% or more as compared to Comparative Example 1.

In other words, as in Example 1, a side surface of the fluororesin block 30, adjacent to the body 10, is formed to have concave and convex forms, so an area in which a fluid is in contact with the body 10, that is, brass, is increased. Thus, an amount of zinc ions released from the zinc block 20 may be increased. Therefore, it is confirmed that a lifespan extension effect of a decrepit pipe and a water quality improvement effect may be improved by the zinc ion water treatment device.

### Experimental Example 2

Six zinc blocks manufactured using a natural cooling method for cooling in air were prepared. A zinc ion water treatment device having the same form as that of Example 1 was manufactured except that the zinc block manufactured as described above is included therein. In other words, Comparative Examples 2 to 7, a zinc ion water treatment device, including a zinc block manufactured using a natural cooling method, were manufactured.

Meanwhile, solid zinc was sintered under conditions of a temperature of 600° C. in a vacuum chamber to form liquid zinc. Then, the liquid zinc was cooled in the same vacuum chamber, and two zinc blocks manufactured thereby were prepared. An ion water treatment device having the same form as that of Example 1 was manufactured except that the zinc block manufactured as described above is included therein. In other words, Examples 2 and 3, a zinc ion water treatment device, including a zinc block manufactured by sintering and cooling in a vacuum chamber, were manufactured.

Then, a zinc elution volume was measured at intervals of 10 minutes in a circulating condition, and is illustrated in Table 1.

TABLE 1

| | | | | | | | | Example | |
|---|---|---|---|---|---|---|---|---|---|
| | | | | | | | | (Vacuum | |
| | | | | | | | | Chamber | |
| | | | | | | | | Cooling | |
| | | Comparative Example (Natural Cooling Method) | | | | | | Method) | |
| | | 2 | 3 | 4 | 5 | 6 | 7 | 2 | 3 |
| Zinc | Raw | 0.2 | | | | | | | |
| Elution | Water | | | | | | | | |
| Volume | 10 min | 0.22 | 0.28 | 0.25 | 0.27 | 0.28 | 0.30 | 0.30 | 0.29 |
| Over | 20 min | 0.24 | 0.30 | 0.28 | 0.27 | 0.28 | 0.30 | 0.33 | 0.40 |
| Elapsed | 30 min | 0.25 | 0.30 | 0.29 | 0.29 | 0.34 | 0.31 | 0.45 | 0.50 |
| Rime | 40 min | 0.25 | 0.32 | 0.30 | 0.32 | 0.36 | 0.33 | 0.57 | 0.51 |
| (mg/L) | 50 min | 0.27 | 0.35 | 0.38 | 0.32 | 0.38 | 0.37 | 0.60 | 0.67 |
| | 60 min | 0.27 | 0.36 | 0.35 | 0.32 | 0.36 | 0.34 | 0.76 | 0.69 |

| | | | | | | | | |
|---|---|---|---|---|---|---|---|---|
| Amount of Increase | 0.07 | 0.16 | 0.15 | 0.12 | 0.16 | 0.14 | 0.56 | 0.49 |
| of Zinc Ions (mg/L) | | | | | | | | |

As can be seen from Table 1, from a zinc elution volume of raw water, 0.2 mg/L, in the case in which a zinc ion water treatment device (Comparative Examples 2 to 7) including a zinc block manufactured using a natural cooling method according to the related art is used, a zinc elution volume was increased to 0.27 mg/L to 0.38 mg/L after 1 hour elapses. However, in the case in which a zinc ion water treatment device (Examples 2 and 3) including a zinc block manufactured using a vacuum chamber cooling method, a zinc elution volume was increased to 0.69 mg/L to 0.76 mg/L.

Thus, in a zinc ion water treatment device of Examples 2 and 3, as compared to a zinc ion water treatment device including a zinc block manufactured using a natural cooling method according to the related art, a zinc elution volume may be increased about three times or more.

1. A zinc ion water treatment device, comprising:
a zinc block having a plurality of through holes in a body, and
a fluororesin block having another plurality of through holes,
wherein a side surface of the fluororesin block is formed to have concave and convex forms to allow a fluid to flow while the fluid is in contact with the body and the fluororesin block.

2. The zinc ion water treatment device of claim 1, comprising:
a rotary flange coupled to each of both ends of the body of the zinc ion water treatment device to be rotated, and having a plurality of fastening holes to be coupled to a flange of a neighboring pipe;
a fixing member installed in each of both ends of the body of the zinc ion water treatment device and fixing the rotary flange to the body;
an insulating layer formed on an inner surface of the rotary flange, and preventing the rotary flange from being directly in contact with the body and the fixing member to prevent potential corrosion by contact between metals different from each other,
wherein a protrusion for fixing a position of the rotary flange is formed on an external surface of both ends of the body to allow the rotary flange to be rotated while being located between the protrusion and the fixing member.

3. The zinc ion water treatment device of claim 1, wherein an area of a side surface of a fluororesin block adjacent to the body is 30% to 90% of a total area of a side surface of the body.

4. The zinc ion water treatment device of claim 1, wherein, in a longitudinal direction in which a fluid flows, a ratio of a length of the fluororesin block and a length of the zinc block is 1:2 to 1:5.

5. The zinc ion water treatment device of claim 1, wherein the insulating layer is formed to be extended from one side surface of a rotary flange corresponding to the protrusion to the other side surface corresponding to a fixing member through an inner surface of the rotary flange.

6. The zinc ion water treatment device of claim 1, wherein the fixing member is screw coupled to the body.

7. The zinc ion water treatment device of claim 1, wherein, between the body and the fixing member, an O-ring for ensuring air tightness is further installed.

8. The zinc ion water treatment device of claim 1, wherein the zinc block is manufactured by sintering solid zinc at 400° C. to 800° C. in a vacuum chamber, and performing cooling at room temperature in the vacuum chamber.

9. A method for manufacturing a zinc ion water treatment device including a zinc block having a plurality of through holes in a body and a fluororesin block having another plurality of through holes, comprising:
sequentially providing a zinc block and a fluororesin block in the body,
wherein a side surface of the fluororesin block is formed to have concave and convex forms to allow a fluid to flow while the fluid is in contact with the body and the fluororesin block, and
the zinc block is manufactured by sintering solid zinc in a vacuum chamber, and performing cooling at room temperature in the vacuum chamber.

10. The method for manufacturing a zinc ion water treatment device of claim 9, wherein the sintering is performed at a temperature of 400° C. to 800° C.
